(19) United States
(12) Patent Application Publication
(10) Pub. No.: US 2015/0121770 A1
(43) Pub. Date: May 7, 2015

(54) IRRIGATION TOWER ANCHOR SYSTEM

(71) Applicant: Lindsay Corporation, Omaha, NE (US)

(72) Inventor: Thomas J. Korus, Lindsay, NE (US)

(73) Assignee: Lindsay Corporation, Omaha, NE (US)

(21) Appl. No.: 14/073,912

(22) Filed: Nov. 7, 2013

(51) Int. Cl. E02D 5/80; A01G 25/09

(52) U.S. Cl. CPC E02D 5/80; A01G 25/09
USPC 52/1; 52/155

(57) ABSTRACT

An anchor system comprising an anchor set in a ground surface and a brace attached to a movable section of an irrigation system. The anchor includes a base configured to engage the ground surface so as to secure the anchor in the ground surface, a vertical member extending upwards from the base, and a head attached near the top of the vertical member and spaced from the ground surface when the anchor is secured in the ground surface. The brace is operable to engage the anchor and includes an open-ended central channel for receiving the head therein and an open-ended slot along a bottom side for receiving the vertical member therein. The slot is narrower than the head so as to prevent the head from passing vertically therethrough.

### BACKGROUND

Embodiments of the present invention relate to anchor systems. More particularly, embodiments of the present invention relate to an improved irrigation tower anchor system for use in a movable irrigation system.

Anchor systems are used in many types of heavy equipment applications in which it is desirable for the equipment to be temporarily secured to prevent the equipment from blowing over or becoming mis-aligned in heavy winds. Conventional anchor systems require an operator to manually secure the equipment to the anchor. This prohibits the anchor systems from being used in large scale operations where multiple pieces of equipment may need to be secured and when the equipment needs to be quickly secured at unpredictable times, such as during times of unexpected high wind speed.

Accordingly there is a need for an improved anchor system that overcomes the above-described limitations.

### SUMMARY

Embodiments of the present invention solve the above-mentioned problems and provide a distinct advance in the art of anchor systems for irrigation towers and other applications. More particularly, embodiments of the invention provide an improved anchor system with a brace and an anchor, wherein the brace is automatically operable to engage the anchor.

One embodiment of the anchor system comprises an anchor configured to be set in a ground surface and a brace attached to a movable section of an irrigation system. The anchor includes a base configured to engage the ground surface so as to secure the anchor in the ground surface, a vertical member extending upwards from the base, and a head attached near the top of the vertical member and spaced from the ground surface when the anchor is secured in the ground surface. The brace is operable to engage the anchor and includes an open-ended central channel for receiving the head therein and an open-ended slot along a bottom side for receiving the vertical member therein. The slot is narrower than the head so as to prevent the head from passing vertically therethrough.

Embodiments of this anchor system provide numerous advantages over conventional anchor systems. For example, the irrigation system can anchor itself by moving the movable section, and hence the brace, to the anchor location. Irrigation systems using controllers and/or location sensors can therefore engage the anchor without an operator. The brace can move to a stored position when not in use to prevent crop damage. Also, the anchor system is easily set up and does not need to be permanently installed.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of an exemplary irrigation system including a plurality of anchor systems constructed in accordance with embodiments of the invention;

FIG. 2 is a perspective view of one of the anchor systems in FIG. 1 including an anchor secured in a ground surface and a brace mounted on an irrigation tower, the brace and anchor engaging each other in accordance with an embodiment of the invention;

FIG. 3 is an end elevation view of the anchor and brace of FIG. 2 particularly illustrating the anchor disposed in the brace in the engaged configuration in accordance with an embodiment of the invention;

FIG. 4 is a perspective view of the anchor and brace of FIG. 2 with the brace in a stored position and the anchor disassembled in accordance with an embodiment of the invention;

FIG. 5 is a perspective view of the brace of FIG. 2 in an engaged position in accordance with an embodiment of the invention; and

FIG. 6 is a perspective view of an anchor and brace with the brace clamped to the irrigation tower and the anchor having a corkscrew shape, constructed in accordance with an embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. It will be understood that elements can be duplicated, rearranged, or reoriented, such as utilizing multiple sensors where only one is described, without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

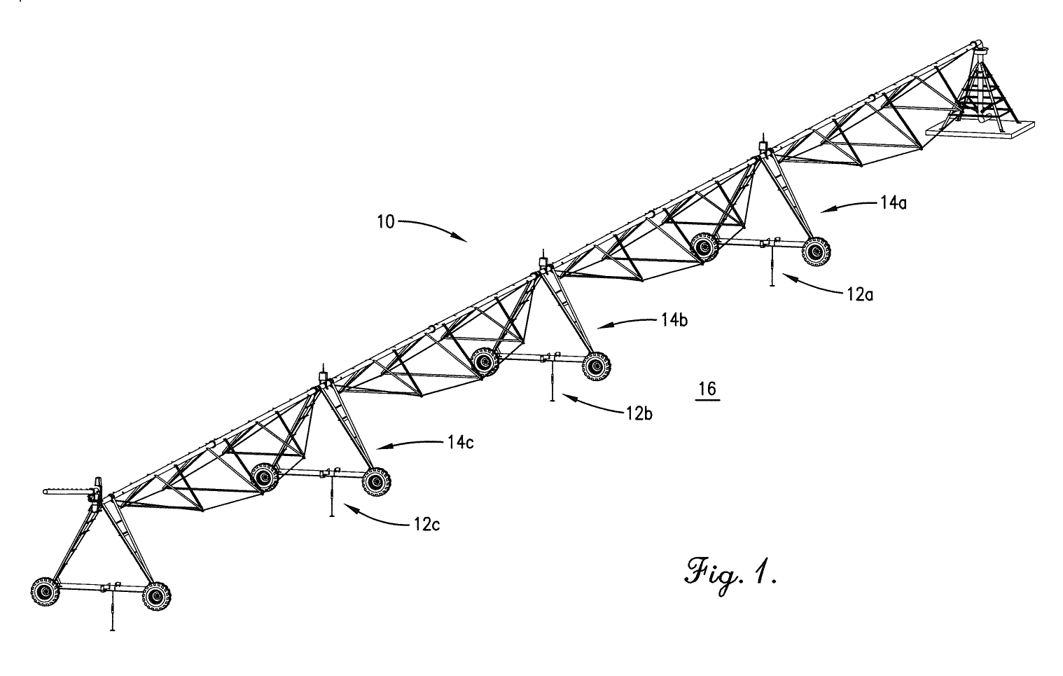

The anchor systems of the present invention may be used to secure any heavy equipment but are especially suitable for movable irrigation systems. An exemplary irrigation system 10 that may be secured with the present invention is shown in FIG. 1 with a plurality of anchor systems 12a, 12b, 12c. The illustrated irrigation system 10 is a center pivot system but the principles of the present invention are also applicable to linear or lateral move irrigation systems and other types of movable irrigation systems. The irrigation system 10 has a plurality of irrigation towers 14a, 14b, 14c for providing support thereto. The irrigation towers 14a-c are configured to move across a ground surface 16. At times it may be desirable to secure the irrigation towers 14a-c to the ground surface 16, such as during storms, high winds, periods of inactivity, or maintenance. For this purpose, the anchor systems 12a-c are incorporated with the irrigation system 10.

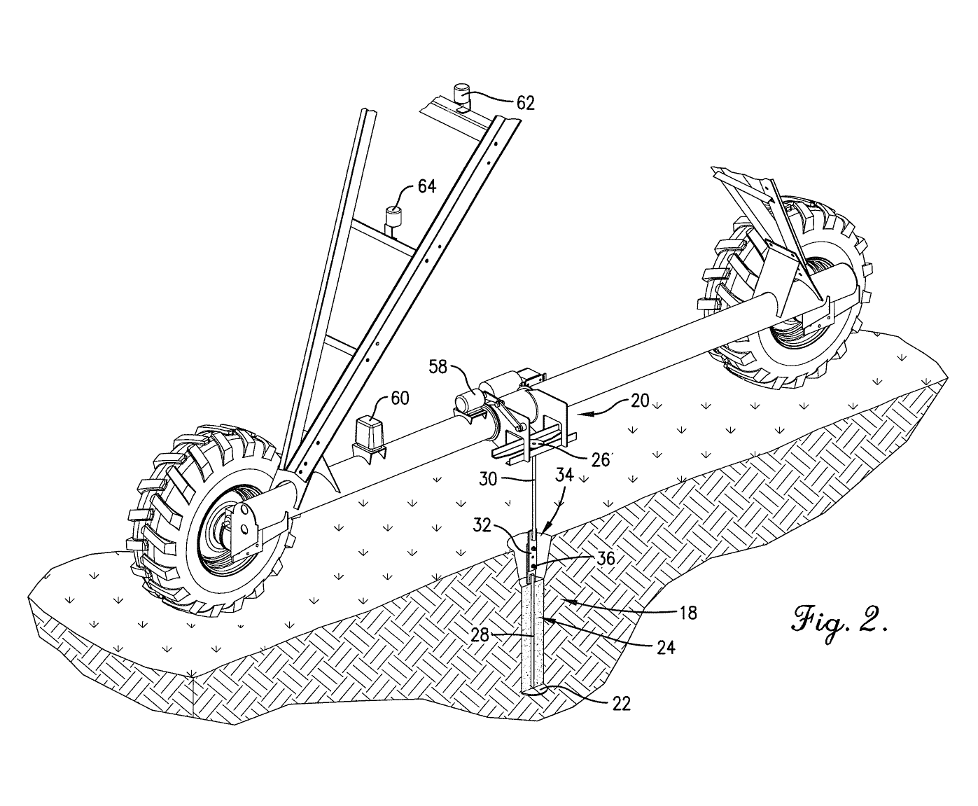

The anchor systems 12a-c may be attached to consecutive irrigation towers, as illustrated in FIG. 1, or to every other irrigation tower. Alternatively, the anchor system(s) 12a-c may be attached in another pattern or arrangement, or on an end irrigation tower only. The anchor systems 12a-c are essentially identical, so only one of them, anchor system 12a, will be described in detail (FIGS. 2-5). The anchor system 12a broadly comprises an anchor 18 and a brace 20 coupled to the irrigation tower 14a and operable to engage the anchor 18.

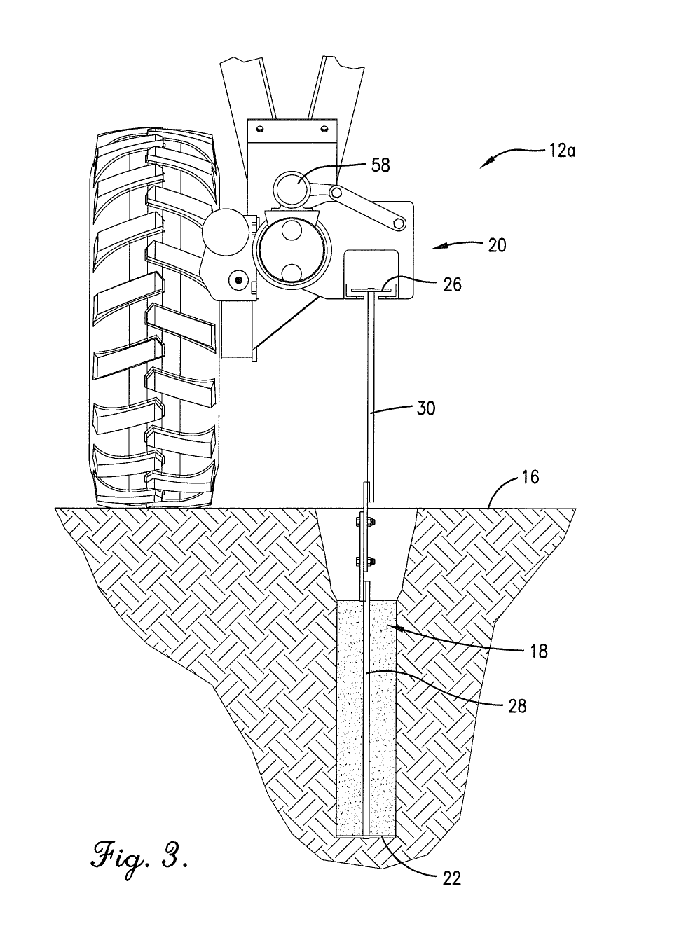

Referring now to FIGS. 2 and 3, the anchor 18 is generally from about 1 to 3 feet tall and may be cylindrical, square, rectangular, or other shape, and may be solid or hollow. The anchor 18 may be formed of any suitable material such as plastic, metal, wood, or composite. The anchor 18 includes a base 22 configured to be buried in or otherwise engage the ground surface 16, a vertical member 24 extending upwards from the base 22 and a head 26 attached near the top of the vertical member 24 and spaced from the ground surface 16 when the base 22 is secured in the ground surface 16.

The base 22 is generally from 2 to 8 inches wide and extends outwards from a lower end of the vertical member 24, so as to entrench the anchor 18 in the ground surface 16 and prevent the anchor 18 from easily being uprooted. The base 22 may be welded, fastened, or frictionally or interlockingly connected to the base 22. The base 22 may be fixedly oriented or may collapse or hinge upwardly against the vertical member 24 for more easily embedding the base 22 into the ground surface 16.

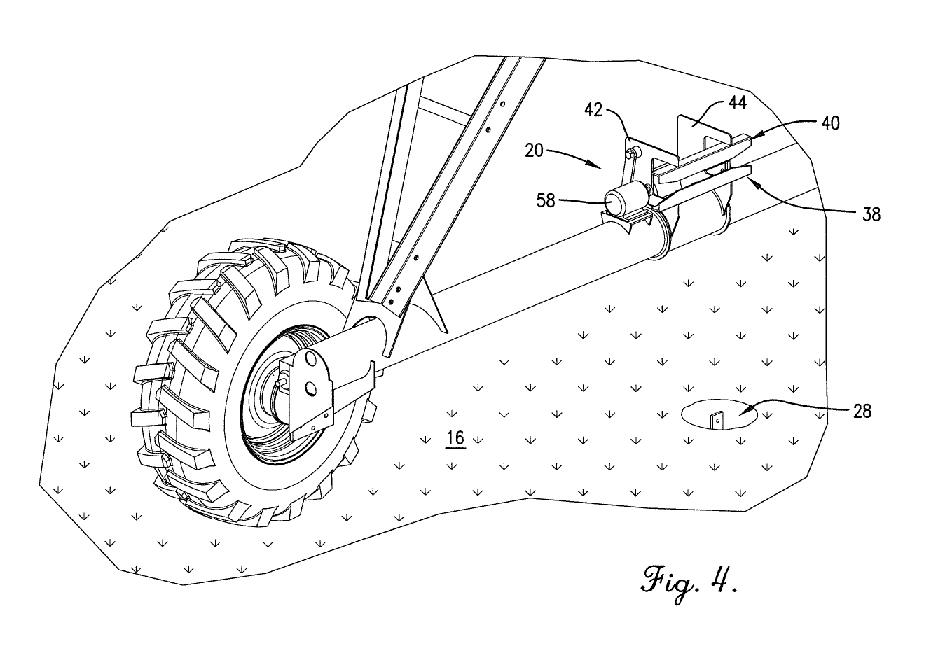

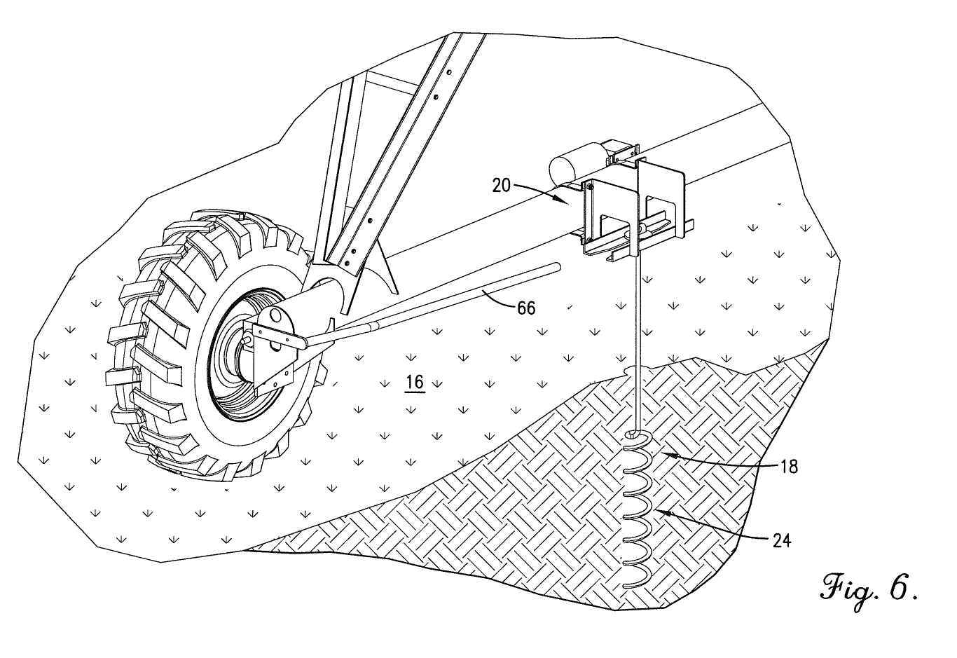

The vertical member 24 is from about 1 to 3 feet tall and from about 1 to 3 inches wide, may have a cylindrical, square, rectangular, or other cross section, and may be solid or hollow. The vertical member 24 extends vertically from the base 22 and supports the head 26. The vertical member 24 may include a lower section 28, an upper section 30, and a coupling structure 32 for securing the sections 28, 30 together. The coupling structure 32 may include a plurality of coupling holes 34a, 34b, 34c for a fastener 36 to be secured through. Securing the fastener 36 in a different coupling hole 34 enables an overall height of the anchor 18 to be adjusted, such as when a wheel track of the irrigation tower 14a becomes sufficiently deep that the anchor 26 should be lowered relative to the brace 20. Installing the anchor 18 to a proper height can be achieved by selecting an appropriate coupling hole 34. Alternatively, the coupling structure 32 may comprise complementary interlocking geometries for easily connecting and disconnecting the lower section 28 and upper section 30. Disconnecting the coupling structure 32 enables the upper section 30 and the head 26 to be removed from the lower section 28. This allows for the anchor parts protruding from the ground surface 16 (upper section 30 and head 26) to be removed (FIG. 4) or lowered into the ground surface 16 when the anchor 18 is not in use or to allow for farming operations without having to dig up and rebury the base 22. Removing or lowering the protruding parts when not in use prevents accidental damage to the anchor 18 and to farm implements. Alternatively, the vertical member 24 may include a bend or a curve, such as a corkscrew shape for screwing into the ground surface 16 (FIG. 6).

Referring again to FIGS. 2 and 3, the head 26 is generally from 2 to 8 inches wide and extends outwards from an upper end of the vertical member 24, for being engaged by the brace 20, as described below. The head 26 can be welded, fastened, or frictionally or interlockingly connected to the vertical member 24.

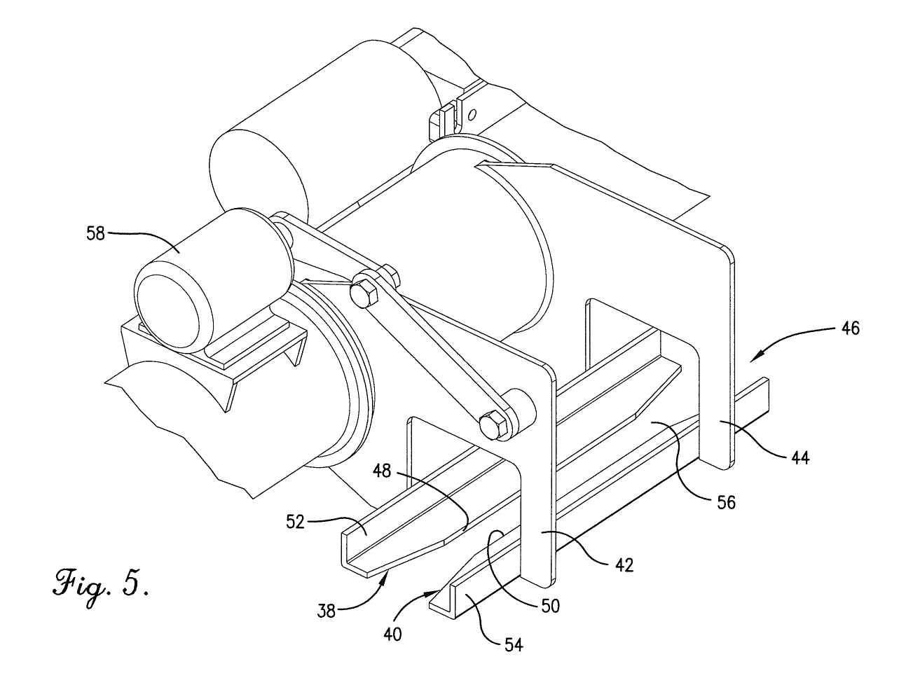

The brace 20 may be welded, fastened, clamped (FIG. 6), or shiftably or pivotally (FIGS. 2 and 3) mounted on the irrigation tower 14a at a height for engaging the head 26. The brace 20 is preferably mounted 12 inches above the ground surface 16 but can be higher or lower. The brace 20 is formed of any suitable material such as metal, plastic, wood, or composite. The brace 20 can take any number of shapes but essentially includes a left guide 38 and a right guide 40 spaced slightly from each other by front and back spacer brackets 42, 44, thereby forming slot 46, as best shown in FIG. 5. The guides 38, 40 include left and right guide surfaces 48, 50 and left and right guide walls 52, 54, collectively forming channel 56 with the spacer brackets 42, 44. The slot 46 is from 1 to 3 inches wide, is sufficiently wide to receive the vertical member 24 therein, is sufficiently narrow to prevent the head 26 from passing vertically therethrough, and is open at both ends to allow the vertical member 24 to pass therethrough. The slot 46 may flare or widen at each end to more easily receive the vertical member 24. Alternatively, the slot 46 may terminate at one end. The channel 56 is from 3 to 7 inches wide to receive the head 26 therein, is bounded by the guide surfaces 48, 50 and the guide walls 52, 54, and is open at both ends to allow the head 26 to pass therethrough. Alternatively, the channel 56 may terminate at one end.

As mentioned above, the brace 20 may be pivotally mounted to the irrigation tower 14a for moving the brace 20 into an engaging position for anchoring the irrigation tower 14a (FIGS. 2 and 3) and for moving the brace 20 into a stored position during normal operation (FIG. 4). For that purpose, a motor 58 is drivably connected to the brace 20 to move the brace 20 between positions. The motor 58 is communicatively coupled to a controller 60 for receiving activation instructions from an irrigation system controller, for receiving wind speed readings from a wind sensor 62a, and/or for receiving a signal from a proximity sensor 64 for determining when the brace 20 is at or near the anchor location. When the brace 20 is engaged with the anchor 18, the motor 58 may also enable the brace 20 to lift up on the anchor 18, thereby removing any slack between the brace 20, anchor 18, and ground surface 16, to more securely anchor the irrigation tower 14a. Alternatively, if the brace 20 is fixedly mounted onto the irrigation tower 14a, the slack between the brace 20 and the anchor 18 may be sufficiently small, e.g., between 0 and 3 inches, that a high wind will remove the slack by lifting up on the irrigation tower 14a and hence the brace 20, thereby securing the brace 20 against the anchor 18.

Embodiments of the present invention may also comprise one or more computer programs stored in or on a computer-readable medium residing on or accessible by the controller 60 of the anchor system 12a. The computer programs may comprise listings of executable instructions for implementing logic functions and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, a portable compact disc read-only memory (CDROM), and “cloud” based servers.

The controller 60 receives positional, angular, velocity, and other signals from the wind sensor 62, proximity sensor 64, and other controllers, performs motion algorithms on the received signals, and instructs the motor 58 to move the brace 20 to the stored or engaged position as a result of the algorithms. The controller 60 or irrigation system controller may also be communicatively coupled to the GNSS for determining a current location of the brace 20. Based on the determined location, the controller 60 instructs the motor 58 to move the brace 20 to the engaging position before or as the brace 20 approaches the anchor 18, and to move the brace 20 to the stored position after or as the brace 20 moves away from the anchor 18. The controller 60 may also instruct the irrigation tower 14a to stop when the brace 20 and anchor 18 are engaged together.

The wind sensor 62 is communicatively coupled to the controller 60 for detecting wind speeds and is mounted to the anchor system 12a or irrigation tower 14a at a height or position conducive to detecting dangerous winds, such as at the top of the irrigation tower 14a. The wind sensor 62 sends wind speed readings to the controller 60.

The proximity sensor 64 is communicatively connected to a motor of the irrigation tower 14a and is operable to sense when the irrigation tower 14a, and hence the brace 20, is at the anchor location. The proximity sensor 64 creates a magnetic field and the anchor 18, being formed of a metal or other magnetically reactive material, disrupts the magnetic field when near the proximity sensor 64. The proximity sensor 64 senses the disruption and generates a signal representative of the proximity of the anchor 18. Alternatively, the proximity sensor 64 may be a laser detector, a radar system, radio frequency system, or other sensor. The proximity sensor 64 is mounted on or near the brace 20 so that it can detect when the brace 20 is near the anchor 18.

In its simplest form, the anchor system 12a is installed by embedding the anchor 18 at a predetermined location in the ground surface 16 in line with the irrigation tower 14a. The location may be chosen at a convenient angle or position in the irrigation system's rotation, or where wind speeds are of most concern. The location may be stored into a memory of the controller 60 or other computer system for performing motion/position algorithms. Locations of other anchor systems 12b and 12c may be chosen to be in line with the location of anchor system 12a, so that all of the anchor systems 12a-c can be engaged simultaneously when the irrigation system 10 is in a straight line.

An anchoring algorithm (i.e., instructing the irrigation tower 14a to move to the anchor location) is initiated and the anchor system 12a is activated when the wind speed sensor 62 detects a wind speed higher than a threshold value. The anchoring algorithm and/or activation of the anchor system 12a can also be initiated by other events. For example, an alert from a weather service forecasting high winds or a dangerous storm can instruct the irrigation tower 14a to return to the anchor 18. As another example, a controller of the irrigation system 10 can detect a hydraulic, mechanical, electrical, or control failure and can instruct the irrigation tower 14a to return to the anchor 18. The anchor system 12a can also be activated at a certain time of day.

When the anchor system 12a is activated, the controller 60 determines a location of the brace 20 in relation to the anchor 18 by communicating with the GNSS or via an angular sensor or proximity sensor 64. The controller 60 then instructs a motor or motors of the irrigation tower 14a or the irrigation system 10 to propel the irrigation tower 14a or the irrigation towers 14a-c, and hence the brace 20 toward the anchor location. The controller 60 can also dictate the speed at which the irrigation tower 14a returns to the anchor, such as 100% of maximum speed for imminent high winds, or 50% of maximum speed for a routine anchoring event. If the anchor 18 or the brace 20 are in the stored position, the controller 60 instructs the motor 58 to move the brace 20 to the engaged position before the brace 20 arrives at the anchor location. When the irrigation tower 14a arrives at the anchor location, the vertical member 24 enters the slot 46 and the head 26 enters the channel 56. When the vertical member 24 is in the slot 46, the head 26 is disposed above the guides 38, 40, which prevents the irrigation tower 14a from overturning in high winds. Note that operation of the anchor system 12a does not require an operator to engage the anchor system 12a or to activate anything. The anchor system 12a engages automatically when the brace 20 arrives at the anchor location. With the brace 20 engaged with the anchor 18, the controller 60 instructs the motor of the irrigation tower 14a to stop. The controller 60 can additionally instruct the motor 58 to raise the brace 20 until it contacts the head 26 so as to securely anchor the brace 20 and irrigation tower 14a.

The anchor system 12a can similarly be deactivated. For example, the anchor system 12a can allow the irrigation tower 14a to revert to its normal path when the wind speed sensor 62 transmits a reading lower than the threshold wind speed. The motor of the irrigation tower 14a is then free to continue propelling the irrigation tower 14a. The brace 20 having the slot 46 and channel 56 with both ends open allows the irrigation tower 14a to continue in its initial direction instead of backtracking. Once the brace 20 is free from the anchor 18, the controller 60 instructs the motor 58 to move the brace 20 to the stored position.

Referring to FIG. 6, the anchor system 12a may also include a crop guard 66 for urging crops (not shown) away from the brace 20 as the irrigation tower 14a passes. The crop guard 66 is elongated and made out of a suitable material such as plastic, metal, wood, or composite. The crop guard 66 is mounted near a front end of the irrigation tower 14a and in front of the brace 20. The crop guard 66 extends rearward and outwardly from the front end so that the crop guard 66 prevents the brace 20 from damaging crops and from crops getting entangled in the brace 20, which could prevent the brace 20 from engaging the anchor 18 properly.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An anchor system for use on a movable irrigation system, the anchor system comprising:
an anchor including a base configured to engage a ground surface so as to secure the anchor on the ground surface, a vertical member extending upwards from the base, and a head attached near a top end of the vertical member and spaced from the ground surface when the anchor is secured in or on the ground surface; and
a brace configured to be coupled to a movable section of the irrigation system and being operable to engage the anchor, the brace including an open-ended central channel for receiving the head therein and an open-ended slot along a bottom side for receiving the vertical member therein, the slot being narrower than the head so as to prevent the head from passing vertically therethrough.

2. The anchor system in claim 1, wherein the channel and slot each present opposite ends, are open-ended at both ends, and are operable to allow the head and vertical member to pass horizontally therethrough, respectively.

3. The anchor system of claim 2, wherein the slot is flared so as to be widest at its ends.

4. The anchor system of claim 1, wherein the vertical member includes an upper section, a lower section, and a coupling structure that permits the upper section and the lower section to be coupled to each other in a plurality of vertical positions so the vertical member has an adjustable overall vertical length.

5. The anchor system of claim 1, wherein the brace is operable to be moved between a stored position and an engaging position.

6. The anchor system of claim 5, further comprising:
a brace motor operable to move the brace between the stored and engaging positions; and
a controller communicatively coupled to the brace motor and operable to instruct the brace motor to move the brace between the stored and engaging positions.

7. The anchor system of claim 1, further comprising:
a sensor operable to sense a proximity of the anchor and generate a proximity reading representative of the proximity of the anchor; and
a controller communicatively coupled to the sensor and to a motor of the movable section, the controller being operable to determine a location of the brace in relation to the anchor based on the proximity reading and to instruct the motor to stop when the brace is in a location for engaging the anchor.

8. The anchor system of claim 1, wherein the brace further includes at least one catch biased towards a closed position and operable to passively allow the anchor to come into engagement with the brace whereby the anchor overcomes a biasing force of the catch and urges the catch towards an open position, the catch further operable to prevent the brace from disengaging from the anchor unless the catch receives an external input.

9. The anchor system of claim 1, further comprising a crop guard mounted to the movable section of the irrigation system and in front of the brace, the crop guard extending rearward and outwardly from the movable section and being operable to urge crops away from the brace when the irrigation system moves along the ground surface.

10. An anchor system for use in a movable irrigation system, the anchor system comprising:
an anchor configured to be secured to a ground surface at a predetermined location;
a brace coupled to a movable section of the irrigation system and operable to engage the anchor when the movable section of the irrigation system and hence the brace is at the predetermined location; and
a controller operable to determine a location of the brace relative to the predetermined anchor location and operable to instruct a motor of the movable section to propel the movable section so as to direct the brace to the predetermined location.

11. The anchor system of claim 10, wherein the controller is communicatively connected to a global positioning satellite system and is operable to receive data representative of the brace location therefrom.

12. The anchor system of claim 10, wherein the movable irrigation system is a center pivot irrigation system and the anchor location and the brace location are represented in angular metrics, the anchor system further comprising an angular sensor operable to detect an angular location of the brace, and the controller being communicatively coupled to the angular sensor for receiving data representative of the angular location of the brace from the angular sensor.

13. The anchor system of claim 10, further comprising:
a wind sensor communicatively coupled to the controller and operable to detect a wind speed and communicate readings representative of the wind speed to the controller, the controller being operable to instruct the motor of the movable irrigation system to propel the movable member so as to direct the brace to the predetermined location when the wind speed exceeds a predetermined value.

14. The anchor system of claim 13, wherein the controller is further operable to instruct the motor to resume normal operation when the wind speed decreases below a predetermined value.

15. The anchor system of claim 10, further comprising:
a brace motor drivably coupled to the brace and operable to move the brace between a stored position and an engaging position, the controller being communicatively coupled to the brace motor and being operable to instruct the brace motor to move the brace to the engaging position when the brace approaches the anchor and to move the brace to the stored position when the brace moves away from the anchor.

16. The anchor system of claim 15, wherein the brace motor is further operable to move the brace into vertical contact with the anchor so as to create a more secure connection therebetween when the brace is in engagement with the anchor.

17. The anchor system of claim 10, wherein the anchor includes an anchor motor operable to retract or extend the anchor between a stored position and an engaging position, respectively, the anchor being completely or mostly contained within the ground when in the stored position.

18. The anchor system of claim 17, wherein the anchor motor is further operable to move the anchor into vertical contact with the brace so as to create a more secure connection therebetween when the brace is in engagement with the anchor.

19. The anchor system of claim 17, wherein the controller is communicatively coupled to the anchor motor and operable to instruct the anchor motor to extend to the engaging position when the brace approaches the anchor and to retract the anchor into the stored position when the brace moves away from the anchor.

20. An anchor system for use in a movable irrigation system, the anchor system comprising:
an anchor configured to be secured to a ground surface at a predetermined location and including a base configured to engage the ground so as to secure the anchor therein, a vertical member extending from the base, and a head near the top of the vertical member and spaced from the ground surface;
a brace coupled to a movable section of the irrigation system and operable to engage the anchor when the brace is at the predetermined location, the brace including an open-ended central channel for receiving the head therein and an open-ended slot along a bottom side for receiving the vertical member therein, the slot being narrower than the head so as to prevent the head from passing vertically therethrough;
a controller operable to determine a location of the brace relative to the predetermined anchor location and operable to instruct a motor of the movable section to propel the movable section so as to direct the brace to the predetermined location; and
a crop guard mounted to the movable section of the irrigation system and in front of the brace, the crop guard extending rearward and outwardly from the movable section and being operable to urge crops away from the brace when the irrigation system moves along the ground surface.
